(19) United States
(12) Patent Application Publication
(10) Pub. No.: US 2006/0029713 A1
(43) Pub. Date: Feb. 9, 2006

(54) Method of producing a heat stable oil-in-water emulsion and the products made therefrom

(75) Inventor: Jason D. Eckert, Forest Lake, MN (US)

Correspondence Address: WESTMAN CHAMPLIN & KELLY, P.A., SUITE 1400 - INTERNATIONAL CENTRE, 900 SECOND AVENUE SOUTH, MINNEAPOLIS, MN, 55402-3319, US

(73) Assignee: Land O'Lakes, Inc., Arden Hills, MN (US)

(21) Appl. No.: 11/247,374

(22) Filed: Oct. 11, 2005

Related U.S. Application Data
(63) Continuation-in-part of application No. 10/823,480, filed on Apr. 13, 2004.

(51) Int. Cl. A23C 15/00

(52) U.S. Cl. 426/581

(57) ABSTRACT

A method of forming a heat stable oil-in-water emulsion comprises providing a selected amount of an aqueous component comprising more than 50 weight percent water. The aqueous component is optionally heated and a selected amount of a solids component is added to the aqueous component under agitation to form a first intermediate. A selected amount of a milk fat containing component is heated to a temperature sufficient to predominantly melt the fat prior to being to the first intermediate to form a second intermediate. The second intermediate is optionally heated for a selected period of time. The second intermediate is homogenized at between about 250 psig and 5000 psig to form the heat stable oil-in-water emulsion comprising less than 30 weight percent milk fat. A thickening agent is added to the homogenized oil-in-water emulsion to form the heat stable oil-in-water emulsion of the present invention.

### CROSS REFERENCE TO RELATED APPLICATIONS

This application is a continuation-in-part of application Ser. No. 10/823,480 filed on Apr. 13, 2004, which is hereby incorporated by reference in its entirety.

### BACKGROUND OF THE INVENTION

The present invention relates to a food composition and method of producing the food composition. More particularly the present invention relates to a base for a food sauce or the completed food sauce and a method of making the base for the food sauce or the food sauce.

Food sauces such as hollandaise sauce, alfredo sauce and Béchamel sauce are typically made to meet demand at full service restaurants. What is meant by food sauce is a sauce having as principle ingredients edible fat or oil, water and solids in an oil-in-water emulsion where the fat or oil may be added separately, or as a component of any ingredient having fat or oil as a component. Many of the preferred sauces are dairy based food sauces. What is meant by dairy based sauce is a sauce having as principle ingredients milk fat, water and solids in an oil-in-water emulsion where the milk fat may be added separately, or as a component of cream, milk, half & half, butter milk solids, butter or any other ingredient having milk fat as a component. What is meant by fat is an edible lipid or blend containing lipids having sufficient solid fat to resist flowing at room temperature. What is meant by oil is an edible lipid or blend containing lipids having sufficient liquid fat to be fluid (flow at room temperature). Edible lipids or lipid blends are included in either the term fat or the term oil.

Full service restaurants spend a significant amount of time and skilled labor preparing food sauces. Food sauces require the correct oil-in-water emulsion typically having a high volume of the dispersed oil component in the continuous water component to be satisfactory to the diners.

Achieving the desired oil-in-water emulsion with the selected high volume of the fat or oil component requires experimentation and skill. Even after developing a standardized recipe there is no guarantee of success because the oil-in-water emulsion may invert and become an water-in-oil emulsion which is unsatisfactory to diners. When a batch of the dairy based sauce is unacceptable, additional time is required to meet the demand for the sauce, potentially causing stress on the restaurant staff and unnecessary delay to the diner.

Many of the food sauces are not temperature stable. Therefore, a large, made from scratch batch of the food sauce cannot be pre-made for use throughout a dining period. Furthermore, when the food sauce is cycled between ambient temperature and a refrigerated temperature, the food sauce has a tendency of “churning out”. What is meant by churning out is an emulsion inversion where the sauce becomes a water-in-oil emulsion where a portion of the water separates from the emulsion. Also, when the food sauces are cycled between a refrigerated temperature or ambient temperature and an elevated cooking temperature the sauces have a tendency of coalescing or “creaming”. By creaming is meant the separation of oil from the water phase where the fat floats on a top surface of the emulsion.

Furthermore, many restaurant food sauces do not exhibit freeze-thaw stability. What is meant by freeze-thaw stability is the ability to be cycled from ambient temperature to below freezing temperature and back without churning out, creaming, or having a complete breakdown of the food sauce emulsion into a discrete aqueous phase and a discrete fat component containing phase. Therefore a full service restaurant has to expend a significant amount of time and resources to produce the food sauces on demand to satisfy its customer's food selections.

### SUMMARY OF THE INVENTION

The present invention includes a method of forming a heat stable oil-in-water emulsion. The method includes providing a selected amount of an aqueous component comprising at least 50 weight percent water. A selected amount of a solids component is added to the aqueous component under agitation to form a first intermediate. A selected amount of a fat containing component is heated to melt the fat containing component. The melted fat containing component is added to the first intermediate to form a second intermediate. The second intermediate may be heated to between about 130° F. and 150° F. for a selected period of time. The second intermediate is homogenized at between about 250 psig and 5000 psig to form the heat stable oil-in-water emulsion comprising less than 30 weight percent fat. A thickening agent is added to the homogenized oil-in-water emulsion to form the heat stable oil-in-water emulsion of the present invention.

### DETAILED DESCRIPTION OF THE PREFERRED EMBODIMENTS

The present invention includes a heat stable oil-in-water emulsion that may be used as a base for a food sauce or as a completed sauce. A preferred embodiment of the heat stable oil-in-water emulsion is a base for a dairy based sauce such as a Béchamel sauce. The oil-in-water emulsion and completed sauces therefrom are useful in the food service industry and particularly in a full service restaurant. The present invention also includes a method of producing the heat stable oil-in-water emulsion that may be used as a base for a variety of dairy based sauces such as the Béchamel sauce.

What is meant by a Béchamel sauce is a sauce that is based on a selected amount of a thickening agent, a selected amount of an oil or fat component, and a selected amount of an aqueous component. A selected amount of solids may optionally be added as an ingredient to the heat stable oil-in-water emulsion. What is meant by a thickening agent is a water absorbing ingredient that is preferably a carbohydrate such as but not limited to flour, starch and gum products such as xanthan gum. The thickening agent is preferably added in a range of between about 0.1 weight percent and 10.0 weight percent of the oil-in-water emulsion.

The heat stable oil-in-water emulsion includes an oil phase that is emulsified within a continuous aqueous component. Suitable ingredients that comprise the aqueous component include, but are not limited to, water, water-containing solutions or emulsions or suspensions or solutions or slurries. Aqueous components may optionally include emulsifiers, such as lecithin, Polysorbate 60 (polyoxyethylene sorbitan monosterate), and/or Complemix 100 (sold by Cytec Industries, Inc. of New Jersey). A nonexhaustive list of aqueous components includes milk, liquid buttermilk, cream, concentrated milk and concentrated cream. Alternative suitable optional components included in the aqueous component include, but are not limited to, solutions of plant proteins, such as soy proteins or other oilseed proteins; cocoa proteins, vegetable proteins; powdered buttermilk; milk protein concentrates; and hydrolyzates of any of these. Other suitable aqueous components include oil-in-water emulsions made by rehydrating dried dairy products. Aqueous components may optionally be cultured with a suitable food-grade organism. The emulsion preferably has a greater percentage of a water phase compared to an oil phase on a weight percentage basis.

The oil phase or fat containing component contributes between about 3 weight percent and 50 weight percent of the total weight of the oil-in-water emulsion. Preferably, the oil component contributes between about 5 weight percent and 25 weight percent of the total weight of the emulsion. The oil phase includes milk fat or a liquid oil or a combination of milk fat and liquid oil. The oil phase or fat containing component is provided as a fluid fat containing component which may be obtained by using an oil, such as vegetable oil or a liquid fraction of a fractionated milk fat, or by providing sufficient heat to a fat containing component, such as butter, lard or hydrogenated vegetable oil, to melt a sufficient amount of the fat containing component so that the fat containing component becomes fluid. The fat containing component may include emulsifiers, including but not limited to lecithin, mono-glycerides, diglycerides, and mixtures thereof.

The aqueous component of the emulsion may include water as a separate ingredient. The aqueous component may also include a dairy ingredient such as a cream that contributes water to the aqueous component and also contributes milk fat to the oil component. What is meant by cream is an oil-in-water emulsion containing from about 18 weight percent fat to about 70 weight percent fat dispersed in an aqueous component. Suitable oil-in-water emulsions include, but are not limited to, dairy-based emulsions such as cream, milk, half & half, and oil-in-water emulsions made by rehydrating dried dairy powders or any other ingredient having milk fat as a component. Other suitable oil or fat containing components include other edible fats and oils, such as but not limited to soybean oil, palm oil, hydrogenated oils, anhydrous milkfat, and interesterified oils, dispersed in an aqueous component. The addition of a liquid oil softens the oil-in-water emulsion at refrigerated temperatures.

Depending upon the ingredients used to contribute to the oil component, water may be directly added as an ingredient as needed to provide the desired oil-in-water emulsion. One skilled in the art will also recognize that fat, water and dairy solids can be combined in desired ratios to produce a mixture that has the same composition and physical properties as the aqueous component.

The heat stable oil-in-water emulsion is preferably produced with the cream having between about 35 weight percent and 45 weight percent fat. The cream contributes between about 5 and 90 weight percent of the total weight of the base and preferably between about 6 weight percent and 40 weight percent of the total weight of the base. Although cream having between about 35 weight percent and about 45 weight percent milk fat is preferred, any aqueous component having more than 18 weight percent fat is within the scope of the present invention. It is also within the scope of the present invention to manufacture an equivalent to the aqueous component by mixing water, solids and a fat containing component to create a desired aqueous component with a selected weight percent solids and fat.

Depending upon the oil content required for the oil-in-water emulsion, additional fat may be added through the addition of a fat containing component such as butter. A typical composition of butter includes 80 weight percent milk fat, 16 weight percent water, 0.85 weight percent protein, 0.06 weight percent lactose, 2.11 weight percent ash and about 1 weight percent salt. Alternatively, the milk fat containing component may be added with other dairy based ingredients containing milk fat such as an anhydrous milk fat that is substantially 100 weight percent milk fat. Another exemplary fat containing composition comprises a vegetable oil or fat such as soybean oil or palm oil; hydrogenated oil, interesterified oil and/or fractionated oil. In order to increase the fat concentration of the oil-in-water emulsion, the fat containing component must have a greater weight percent fat than the aqueous component.

The heat stable oil-in-water emulsion may also contain solids including proteins that may be contained within both the oil phase and the water phase. Suitable solids include materials include dairy based solids such as, but not limited to, non-fat dry milk, buttermilk solids, milk protein concentrates, dried whey, whey protein concentrates, whey protein isolates such as sodium caseinate, soy proteins, soy protein isolates, cocoa powder, defatted cocoa powder, cheese, or any other form of protein-containing solids. Additional solids are optionally added to the oil-in-water emulsion to increase the body, the viscosity, the thickness and improve the mouthfeel of the base. The amount of solids is determined on a solids non-fat basis (SNF) by the following formula where each of the concentrations is a weight percent of the total weight of the oil-in-water emulsion.

$$SNF = \frac{( protein + carbohydrate + minerals )}{( water + protein + carbohydrate + minerals )} \times 100$$

The solids non-fat may reach up to 24 weight percent of the total weight of the emulsion. However, at elevated concentrations, the SNF concentrations may make the emulsion dry, pasty and gummy at refrigerated temperatures.

An exemplary ingredient used to increase the solids in the oil-in-water emulsion is a non-fat dry milk (NFDM) solids component. The NFDM solids component preferably contributes between about 3 and 12 weight percent of the total weight of the oil-in-water emulsion. The NFDM typically consists of about 51 weight percent carbohydrate, about 36 weight percent protein, about 1 weight percent fat, about 4 weight percent minerals and about 8 weight percent ash and salt. An exemplary NFDM is manufactured by Land O'Lakes of Arden Hills, Minn. The NFDM can be either a high heat NFDM or a low heat NFDM. Other ingredients can be used to increase the solids content in the oil-in-water emulsion including whey protein, whey protein concentrate, milk protein concentrate, sodium caseinate, and maltodextrin, such as M100 manufactured by Grain Processing Corporation of Muscatine, Iowa.

The heat stable oil-in-water emulsion may also contain emulsifiers. Water-soluble emulsifiers may be added to the aqueous component, and fat-soluble emulsifiers may be added to the fat containing component. Alternatively, suitable emulsifiers may be added to more than one component or intermediate. A suitable water-soluble emulsifier is Polysorbate 60, and a suitable fat-soluble emulsifier is lecithin.

Upon obtaining the desired ratios of oil to water and solids to water and/or oil, the mixture is homogenized to create a heat stable oil-in-water emulsion. A slurry of water and an effective amount of the thickening agent is added to the homogenized emulsion and mixed therein to produce the composition of the finished base.

The base is heated for a selected amount of time at between about 150° F. and 190° F. to pasteurize the base. Once pasteurized, the base is optionally cooled for a selected amount of time to between about 40° F. and 70° F. The food sauce base is heat stable and has the organoleptic properties of a made from scratch diary based sauce including a Béchamel sauce when reconstituted.

Besides water, fat and solids, other non-essential ingredients may also be added such as stabilizers. A non-exhaustive list of stabilizers and emulsifiers includes polysorbate, lecithin, beta carotene (also added for color), sodium benzoate, potassium sorbate, and Complemix 100. The emulsifiers are added to aid in emulsifying the oil component into the water component and to impart thermal stability. The stabilizers are optionally added to maintain the stability of the oil-in-water emulsion.

Additional, but optional, enhancing ingredients may be added to the mixture. The enhancing ingredients are added to enhance the flavor, texture, or appearance of the base. However, the enhancing ingredients are not necessary to produce the food sauce base of the present invention. A non-exhaustive list of enhancing ingredients that may optionally be added to the base of the present invention includes flavorants, such as lemon juice, lemon juice powder, reconstituted lemon juice, egg flavor, a lactic acid starter blend, a starter distillate, flavors, and salt; acidulates such as edible acids and edible acid anhydrides, including citric acid, hydrochloric acid, lactic acid, lemon juice powder, and glucono delta lactone; cheese; enzyme modified cheese; eggs; edible particulates such as bread crumbs, chopped nuts, meat, fruits, dried vegetables; herbs and seasonings; cordials and alcoholic beverages such as wine or beer; cocoa liquor; sweeteners such as sugar or corn syrup; artificial sweeteners; and starch. Additionally, colorants such as annatto, beta-carotene, turmeric, FD&C dyes, and titanium dioxide may be optionally added to enhance the color of the sauce to be made from the heat stable oil-in-water emulsion of the present invention.

To prepare an embodiment of a heat stable oil-in-water emulsion, a selected amount of water, a selected amount of a liquid oil such as liquid soy oil and a selected amount of cream are mixed together to form the aqueous component. Dry ingredients including selective amounts of salt, potassium sorbate, NFDM, and sucrose are added to the liquid aqueous component and mixed therein.

A selected amount of the edible acid is optionally added to the aqueous component. The edible acid may be added to adjust the taste and pH of the completed oil-in-water emulsion. The edible acid can be added in a range up to about 1.0 weight percent.

The aqueous component is heated to a temperature sufficient to make the fat in the aqueous component fluid, typically greater than about 104° F., while the aqueous component is subjected to agitation or shear. Preferably the aqueous component is heated to about between about 115° F. and 150° F. The aqueous component is preferably heated with methods that do not add moisture to the cream such as but not limited to, a double boiler or a steam jacketed vessel. The aqueous component is preferably heated to a temperature sufficient to prevent whipping and churning when agitation or shear is applied.

The fat containing portion or oil component, preferably butter, is added to increase the volume and weight percent of the oil component and also to impart a creamier mouth-feel to the sauce made from the oil-in-water emulsion. Fat-soluble emulsifiers may be optionally added to the fat containing component to promote temperature stability of the oil-in-water emulsion including Polysorbate 60 and lecithin. If water-soluble emulsifiers are absent from the aqueous component, fat-soluble emulsifiers are preferably added to the fat containing component. The butter contributes between about 1 and 20 weight percent of the total weight of the emulsion and preferably between about 3 and 10 weight percent of the total weight of the emulsion. The butter is preferably heated to melt a sufficient amount of the butter so that the butter becomes fluid, such as to between about 110° F. and 170° F. and preferably to between about 120° F. and 140° F. prior to being added to the aqueous component. Preferably, the fat containing component is added to the aqueous component under agitation to evenly dispense the fat containing component into the aqueous component.

The mixture of at least the aqueous component and the fat containing component is agitated for a select period of time. Preferably the mixture is agitated at a temperature at a range of between about 120° F. and about 150° F. for about 5 minutes.

The mixture is then homogenized. The mixture is homogenized at between about 500 psig and 5000 psig and preferably at between about 1500 psig and 2500 psig. The mixture is preferably homogenized through a single stage homogenizer, however homogenization with a multiple stage homogenizer is also within the scope of the present invention.

A thickening agent such as flour, starch or xanthan gum or any combination thereof is mixed into water for about 5 minutes in an amount effective to form a slurry. The slurry preferably includes between about 30% and about 35% total solids. A nonexhaustive list of suitable starch components include Ultra Sperse M, Frigex W and Frigex HV all of which are manufactured by National Starch and Chemical Company of Bridgewater, N.J. A suitable xanthan gum includes Ketrol 521 manufactured by C.P. Kelco of Atlanta, Ga.

A selected amount of the edible acid is optionally added to the mixture of starch and water. The edible acid may be added to adjust the taste, pH and viscosity of the completed oil-in-water emulsion. The edible acid can be added in a range up to about 1.0 weight percent. Preferably, a portion of the edible acid is added to the slurry and a portion is added to the aqueous component. However, the edible acid may be added only to the aqueous component or only to the slurry while practicing the present invention.

The mixture of water, the thickening agent and the edible acid is heated to between about 120° F. and about 140° F. under agitation. The mixture of the thickening agent, water and the edible acid is added to the homogenized emulsion and mixed into the homogenized emulsion for an amount of time effective to evenly disperse the thickening agent and the edible acid therein. A preferred amount of time for mixing is about 5 minutes. Alternatively, the slurry containing the thickening agent may be added to the emulsion prior to the homogenization step such that the thickening agent is also subjected to the homogenization process. However, some degradation of the structure of the thickening agent will occur, resulting in a thinner, less viscous base and reconstituted sauce.

The mixture exiting the homogenizer is at a temperature of between about 110° F. and 150° F. and is heated to at least about 135° F. for at least 15 seconds. Preferably the thickened oil-in-water emulsion is heated in a scraped surface heat exchanger that is heated with hot water, steam or a hot oil to about 185° F. for about 15 seconds. However, a batch pasteurization process is also within the scope of the present invention, including heating the homogenized emulsion to between about 150° F. and 160° F. for about 30 minutes.

The heated oil-in-water emulsion is preferably cooled to a temperature range of between about 40° F. and 70° F. and preferably to a temperature range of 40° F. and 60° F. An exemplary cooler is a scraped surface heat exchanger that cools by employing chilled water or another cooling agent to cool the emulsion. With the mixture cooled to the selected temperature, the oil-in-water emulsion has a consistency of a gravy. However, it is within the scope of the present invention for the oil-in-water emulsion to be packaged directly after the pasteurization step.

The cooled oil-in-water emulsion is packaged into a desired container which is subsequently used by full service restaurants as a base for dairy based sauces. The cold filled dairy base is preferably stored under refrigeration to extend the shelf life.

The oil-in-water emulsion can be prepared as a ready to use sauce or as a concentrate that is diluted with a liquid such as water or milk. The oil-in-water emulsion can be concentrated up to four times the sauce concentration meaning that for every one part of the emulsion used four parts of the liquid must be used to dilute the concentrate. A preferred concentration is between about one times the sauce concentration and about two times the sauce concentration. In the preferred concentration range the liquid easily mixes into the concentrate and the concentrate is more easily handled. However, an oil-in-water concentrate of any concentration that produces an acceptable sauce when reconstituted is within the scope of the present invention.

After combining the oil component with the aqueous component, the mixture may alternatively be heated to pasteurization temperatures prior to being homogenized. The slurry containing the thickening agent is added to the homogenized emulsion and mixed therein to produce the base. The base is subsequently cooled and packaged. The base can also be packaged directly after the addition of the slurry.

The restaurant uses the heat stable oil-in-water emulsion as a finished ready-to-use sauce, or as a base to make dairy based sauces such as, but not limited to, a Béchamel sauce by adding additional ingredients as desired by the restaurant. However, unlike made from scratch sauces, the oil-in-water emulsion is heat stable and capable of being cycled from refrigerated temperatures to cooking temperatures and back without churning out or creaming. Utilizing the heat stable oil-in-water emulsion as a base for the dairy based sauces, allows the employees of the restaurant only to add the ingredients necessary to make the desired sauce and thereby eliminates the need to make the sauce from scratch and the risk of making an unsatisfactory sauce due to an unstable oil-in-water emulsion.

It has been discovered that the process of the present invention and the resulting products manufactured by the process are heat stable, being able to be cycled from a refrigerated temperature to a steam table and back without churning out at lower temperatures or creaming at elevated temperatures. Additionally, the dairy base can be stored in a refrigerated environment for a period of time and when used to produce a dairy based sauce provides the organoleptic properties of a freshly made sauce. The following Examples are illustrative only and are not intended to limit the present invention in any way.

### EXAMPLE 1

A base for a Béchamel sauce was produced using the following formulation.

TABLE 1

| | Approximate |
|---|---|
| Ingredient | Weight percent |
| Water | 41.66 |
| Cream (40 weight % fat) | 30.73 |
| Liquid soy oil | 3.50 |
| NFDM solids¹ | 8.52 |
| Lactic Acid (88%) | 0.23 |
| Sucrose | 1.00 |
| Salt | 1.00 |
| Potassium sorbate | 0.13 |
| Starch (Frigex W)² | 6.15 |
| Butter - salted | 7.00 |
| Tween 60³ | 0.04 |
| Lecithin | 0.04 |
| TOTAL | 100.00 |

¹Non-fat dry milk.
²Modified starch - National Starch and Chemical Company, New Jersey.
³Polyethylene sorbitan monostearate

The cream, liquid soy oil and about 74.5 weight percent of the water were mixed together to form an aqueous continuous mixture that was heated to about 140° F. in a double boiler. The aqueous continuous mixture was transferred to a blender. The NFDM solids, one-half of the lactic acid on a weight percent basis, salt, sucrose and potassium sorbate were mixed to create a uniform mixture that was added to the aqueous continuous mixture under agitation.

The butter was heated in a separate container to about 140° F. such that the butter melted and was at the approximate temperature of the aqueous continuous mixture. The Tween 60 and lecithin were added to the melted butter under agitation to uniformly disperse the emulsifiers into the butter to form an oil continuous component. The heated oil continuous component was added to the aqueous continuous component under agitation to evenly disperse the oil continuous component into the aqueous continuous component thereby forming an intermediate. The intermediate was maintained at 140° F. under agitation for about 30 minutes.

The intermediate was homogenized at about 1500 psig through a single stage homogenizer. A heat stable oil-in-water emulsion exited the homogenizer at about 140° F.

The starch and about one half of the lactic acid ingredient was added to about 25.5 weight percent of the water ingredient to form a slurry. The slurry was added to the homogenized oil-in-water emulsion under agitation to form the base of the present invention.

The base was heated to about 155° F. for about 15 seconds and then rapidly cooled in a refrigeration unit. The base contained about 60.38 percent water, about 21.77 weight percent fat, about 39.62 weight percent total solids and about 17.85 weight percent solids non-fat.

The heat stable oil-in-water emulsion or base was found to be repeatedly cyclable from refrigerated temperature to cooking temperatures and back to the refrigerated temperature without churning out or creaming. In addition, the heat stable oil-in-water emulsion demonstrated excellent freeze-thaw stability. The base was a concentrate that was reconstituted with about two times the weight of the base and when reconstituted had the organoleptic properties of a made from scratch Béchamel sauce while containing about 7.26 weight percent fat.

### EXAMPLE 2

A series of trials were conducted to determine the effect of reducing the fat content of the oil-in-water emulsion base for a Béchamel sauce. The base in example 1 had a fat content of 21.77 weight percent, the bases in the present example had a fat content of 15 weight percent, 10 weight percent and 5 weight percent. Also xanthan gum was added to the slurry containing the starch which subsequently was mixed into the homogenized emulsion. Trials 2-5 had the following formulations.

TABLE 2

| | Trial 2 | Trial 3 | Trial 4 | Trial 5 |
|---|---|---|---|---|
| | App. | App. | App. | App. |
| Ingredient | Wt. % | Wt. % | Wt. % | Wt. % |
| Water | 53.98 | 63.99 | 62.73 | 71.42 |
| Cream (40 weight % fat) | 20.71 | 13.27 | 14.00 | 8.00 |
| Liquid soy oil | 2.38 | 1.60 | 1.60 | 0.75 |
| NFDM solids^{1.} | 9.03 | 9.40 | 9.35 | 9.72 |
| Lactic Acid (88%) | 0.23 | 0.23 | 0.23 | 0.23 |
| Sucrose | 1.00 | 1.00 | 1.00 | 1.00 |
| Salt | 1.00 | 1.00 | 1.00 | 1.00 |
| Potassium sorbate | 0.13 | 0.13 | 0.13 | 0.13 |
| Starch (Frigex W)^{2.} | 6.65 | 6.15 | 6.65 | 7.00 |
| Butter - salted | 4.76 | 3.20 | 3.20 | 1.60 |
| Tween 60^{3.} | 0.04 | 0.02 | 0.02 | 0.02 |
| Lecithin | 0.04 | 0.02 | 0.02 | 0.02 |
| Xanthan gum | 0.05 | 0.00 | 0.07 | 0.12 |
| Total wt. % | 100.00 | 100.00 | 100.00 | 100.00 |
| Wt. % fat | 14.8 | 10.0 | 10.0 | 5.0 |
| Wt. % water | 67.02 | 72.35 | 71.91 | 76.62 |
| Wt. % total solids | 32.98 | 27.65 | 28.09 | 23.38 |
| Wt. % SNF⁴ | 18.15 | 17.65 | 18.09 | 18.38 |

^{1.}Non-fat dry milk.
^{2.}Modified starch - National Starch and Chemical Company, New Jersey.
^{3.}Polyethylene sorbitan monostearate.
⁴Solids on a non-fat basis.

The procedure disclosed in Example 1 was used to produce the bases in trials 2-5. The weight percent of the NFDM was adjusted to compensate for the loss of solids non-fat as the weight percent of cream was reduced to make lower fat bases. Preferably, the weight percent of NFDM was adjusted such that the incremental increase from 8.00 weight percent in addition to the solids non-fat added to added with the cream contributed about 2.0 solids non-fat to the base. Also, as the weight percent fat was decreased, the weight percent of the thickening agent(s) were increased to maintain the organoleptic properties of a made from scratch Béchamel sauce when reconstituted.

While the viscosity of the refrigerated base and the reconstituted hot viscosity were lower than the high fat base in Example 1, the organoleptic properties of each of the reduced fat bases were similar to that of a made from scratch Béchamel sauce when reconstituted and were acceptable in taste, appearance and mouth feel. It was discovered that the addition of xanthan gum to the base resulted in the retention of air in the reconstituted sauce created during the mixing process, but the reconstituted base was acceptable in appearance, taste and mouthfeel.

The heat stable oil-in-water emulsion or base was found to be repeatedly cyclable from refrigerated temperature to cooking temperatures and back to the refrigerated temperature without churning out or creaming. In addition, the heat stable oil-in-water emulsion demonstrated excellent freeze-thaw stability. The base was a concentrate that was reconstituted with about two times the weight of the base and when reconstituted had the organoleptic properties of a made from scratch Béchamel sauce with a significant reduction of the fat content of the sauce.

### EXAMPLE 3

The oil-in-water emulsion of the present invention was prepared using the formulation for the emulsion of Trial 3 in Example 2 to test the effect of adding maltodextrin with the thickening agent to increase the solids content of the emulsion. The emulsion includes about 10 weight percent fat as compared to an emulsion with about 21.8 weight percent fat in Example 1. The emulsions had the following formulations.

TABLE 3

| | Trial 6 | Trial 7 |
|---|---|---|
| Ingredient | Wt. % | Wt. % |
| Water | 60.24 | 56.92 |
| Cream (40 weight % fat) | 12.49 | 11.80 |
| Liquid soy oil | 1.51 | 1.42 |
| NFDM solids^{1.} | 8.85 | 8.36 |
| Lactic Acid (88%) | 0.22 | 0.20 |
| Sucrose | 0.94 | 0.89 |
| Salt | 0.94 | 0.89 |
| Potassium sorbate | 0.122 | 0.116 |
| Starch (Frigex W)^{2.} | 5.79 | 5.47 |
| Butter - salted | 3.01 | 2.85 |
| Tween 60^{3.} | 0.018 | 0.018 |
| Lecithin | 0.018 | 0.018 |
| Maltodextrin | 5.85 | 11.06 |
| Total wt. % | 100.00 | 100.00 |

^{1.}Non-fat dry milk.
^{2.}Modified Starch - National Starch and Chemical Company, New Jersey.
^{3.}Polyethylene sorbitan monostearate.

The trials 6 and 7 were produced using the same method as used to produce Trial 3. The maltodextrin was added to the slurry containing the starch and was added after the homogenization step. The maltodextrin used in Trials 6 and 7 was M100 manufactured by Grain Processing Corporation located in Muscatine, Iowa. The total solids were increased to about 33.87 weight percent in Trial 6. The total solids were increased to about 40.08 weight percent in Trial 7 which is approximately the same amount of total solids in Trial 1 in Example 1.

While the total solids were increased by adding maltodextrin, the refrigerated viscosity of the concentrated base was significantly reduced when compared to the concentrated base of the same formulation without maltodextrin. While the total solids were increased with the addition of maltodextrin, in both trials 6 and 7, the refrigerated viscosity of the concentrated base was reduced by more than a factor of 10, from 185,000 cp to about 14,000 cp. When reconstituted to form a Béchamel sauce and heated to a temperature of about 170° F., the viscosity was reduced from 310 cp to about 200 cp, or a reduction of more than one third.

The heat stable oil-in-water emulsion or base with maltodextrin was found to be repeatedly cyclable from refrigerated temperatures to cooking temperatures and back to the refrigerated temperature without churning out or creaming. In addition, the heat stable oil-in-water emulsion demonstrated excellent freeze-thaw stability. The base was a concentrate that was reconstituted with about two times the weight of the base and when reconstituted had the organoleptic properties of a made from scratch Béchamel sauce.

### EXAMPLE 4

A series of trials were conducted to evaluate the effect of the use of different sources of cream on the oil-in-water emulsion as well as the effect of homogenization pressure on the organoleptic properties of the base. The cream used in Trials 8 and 9 was Heavy Whipping Cream manufactured by Land O'Lakes, Inc. of Arden Hills, Minn. The cream used in Trial 10 was Supreme™ cream manufactured by Land O'Lakes, Inc. of Arden Hills, Minn. The formulations are as follows.

TABLE 4

| | Trial 8 | Trial 9 | Trial 10 |
|---|---|---|---|
| Ingredient | Wt. % | Wt. % | Wt. % |
| Water | 46.18 | 42.847 | 46.18 |
| Cream | 30.00 | 33.333 | 30.00 |
| Liquid soy oil | 3.00 | 3.00 | 3.00 |
| NFDM solids^{1.} | 8.00 | 8.36 | 8.00 |
| Salt | 1.00 | 1.00 | 1.00 |
| Starch (Frigex W)^{2.} | 5.75 | 5.75 | 5.75 |
| Butter - salted | 6.00 | 6.00 | 6.00 |
| Tween 60³ | 0.035 | 0.035 | 0.035 |
| Lecithin | 0.035 | 0.035 | 0.035 |
| Total wt. % | 100.00 | 100.00 | 100.00 |

^{1.}Non-fat dry milk.
^{2.}Modified Starch - National Starch and Chemical Company, New Jersey.
³Polyethylene sorbitan monostearate.

Each of the oil-in-water emulsions was made using the procedure disclosed in Example 1. However, the homogenization pressure was varied to determine the effect of homogenization pressure on the base and the reconstituted sauce. The emulsion of trial 8 was homogenized at 500 psig, 1500 psig and 2500 psig. The results showed that the base homogenized at 500 psig, while acceptable was thinner that the base homogenized at 1500 psig. The base homogenized at 2500 psig was similar in consistency to the base homogenized at 1500 psig. The bases of Trials 9 and 10 were also homogenized at 1500 psig and were found to have similar consistencies as that of the base of Trial 8 that was homogenized at 1500 psig. Based upon the results of the present trials, it was observed that varying the homogenization pressure between 500 psig and 1500 psig had an effect on the consistency of the base. However, homogenization at pressures greater than 1500 psig, such as 2500 psig, while producing an acceptable base, did not materially affect the consistency of the base.

The results of the trials also indicated that the source of the cream does not have a significant impact on the organoleptic properties of the base or reconstituted sauce. However, as expected, a base with a higher fat content produced a reconstituted sauce with a creamier and smoother mouthfeel and taste.

### EXAMPLE 5

A series of trials were conducted to evaluate the effect of the use of different sources of NFDM on the oil-in-water emulsion as well as the effect of homogenization pressure on the organoleptic properties of the base. The NFDM used in Trials 11 was low heat NFDM manufactured by Land O'Lakes, Inc. of Arden Hills, Minn. The NFDM used in Trial 12 was high heat NFDM manufactured by Land O'Lakes, Inc. of Arden Hills, Minn. The formulations are as follows.

TABLE 5

| | Trial 11 | Trial 12 |
|---|---|---|
| Ingredient | Wt. % | Wt. % |
| Water | 46.18 | 46.18 |
| Cream | 30.00 | 30.00 |
| Liquid soy oil | 3.00 | 3.00 |
| NFDM solids | 8.00 | 8.00 |
| Salt | 1.00 | 1.00 |
| Starch (Frigex W)² | 5.75 | 5.75 |
| Butter - salted | 6.00 | 6.00 |
| Tween 60³ | 0.035 | 0.035 |
| Lecithin | 0.035 | 0.035 |
| Total wt. % | 100.00 | 100.00 |

¹Non-fat dry milk.
²Modified Starch - National Starch and Chemical Company, New Jersey.
³Polyethylene sorbitan monostearate.

Trials 11 and 12 were run using the process detailed in Example 1. However, the homogenization pressures were varied to determine the effect of homogenization pressure on the base and the reconstituted sauce. The ingredients of Trial 11 were homogenized at pressures of 500, psig, 1500 psig and 2500 psig. The oil-in-water emulsion that was homogenized at 500 psig had a thinner consistency than the same oil-in-water emulsion homogenized at 1500 psig. The oil-in-water emulsion had a similar consistency when homogenized at 1500 psig and 2500 psig where both emulsions had a thick and smooth appearance.

The oil-in-water emulsion of trial 12 was homogenized at both 500 psig and 2500 psig. The oil-in-water emulsion that was homogenized at 2500 psig was thicker and had a smoother appearance than the same oil-in-water emulsion that was homogenized at 500 psig.

The use of low heat NFDM or high heat NFDM did not have a significant affect on the organoleptic properties of the oil-in-water emulsion.

The only difference being a slight difference in flavor between the two reconstituted emulsions. Therefore, a base containing either low heat NFDM or high heat NFDM produced an acceptable oil-in-water emulsion to be used as a base for a reconstituted sauce.

### EXAMPLE 6

A series of trials were conducted to test the effectiveness of substituting milk protein concentrate (MPC) for NFDM. The formulations for the Trials are as follows.

TABLE 6

| | Trial 13 | Trial 14 | Trial 15 | Trial 16 | Trial 17 | Trial 18 | Trial 19 |
|---|---|---|---|---|---|---|---|
| Ingredient | Wt. % | Wt. % | Wt. % | Wt. % | Wt. % | Wt. % | Wt. % |
| Water | 46.18 | 47.92 | 46.20 | 45.20 | 50.10 | 48.15 | 49.82 |
| Cream¹ | 30.00 | 29.03 | 30.00 | 30.00 | 30.00 | 30.00 | 29.03 |
| Liquid soy oil | 3.00 | 2.90 | 3.00 | 3.00 | 3.00 | 3.00 | 2.90 |
| NFDM solids² | 8.00 | 7.74 | 0.00 | 0.00 | 0.00 | 0.00 | 0.00 |
| MPC 4700³ | 0.00 | 0.00 | 4.08 | 4.08 | 4.08 | 4.08 | 3.95 |
| Sucrose | 0.00 | 0.00 | 0.00 | 1.00 | 0.00 | 0.00 | 0.00 |
| Salt | 1.00 | 0.97 | 1.00 | 1.00 | 1.00 | 1.00 | 0.97 |
| Starch (Frigex W)⁴ | 5.75 | 5.57 | 5.75 | 5.75 | 5.75 | 7.70 | 7.45 |
| Butter - salted | 6.00 | 5.81 | 6.00 | 6.00 | 6.00 | 6.00 | 5.81 |
| Tween 60⁵ | 0.035 | 0.034 | 0.035 | 0.035 | 0.035 | 0.035 | 0.034 |
| Lecithin | 0.035 | 0.034 | 0.035 | 0.035 | 0.035 | 0.035 | 0.034 |
| Maltodextrin⁶ | 0.00 | 0.00 | 3.900 | 3.900 | 0.00 | 0.00 | 0.00 |
| Total wt. % | 100.00 | 100.00 | 100.00 | 100.00 | 100.00 | 100.00 | 100.00 |
| Wt. % moisture | 64.74 | 66.90 | 64.69 | 64.69 | 68.44 | 66.68 | 68.90 |
| Wt. % total solids | 35.26 | 34.12 | 35.31 | 35.31 | 31.56 | 33.32 | 32.25 |
| Wt. % solids non-fat | 15.39 | 14.89 | 15.45 | 15.45 | 11.71 | 13.46 | 13.03 |
| Wt. % fat | 19.87 | 19.23 | 19.86 | 19.86 | 19.86 | 19.86 | 19.22 |

¹The cream used in Trials 13-19 was Heavy Whipping Cream manufactured by Land O'Lakes, Inc. of Arden Hills, Minnesota.
²Non-fat dry milk.
³The milk protein concentrate MPC 4700 is Alapro 4700 manufactured by Fonterra Co-operative Group Ltd of New Zealand.
⁴Modified Starch - National Starch and Chemical Company, New Jersey.
⁵Polyethylene sorbitan monostearate.

Each of the emulsions was produced using the following procedure. The starch, salt and sucrose, if included as an optional ingredient, was added to an amount of water to make a slurry containing between about 30 weight percent and about 35 weight percent total solids.

The remaining water was heated to between about 160° F. and about 165° F. and poured into a blender. The NFDM or MPC was added to the blender and mixed therein until the mixture was of a substantially uniform consistency. If provided in the formula, the maltodextrin was added to the mixture of NFDM and/or MPC and mixed therein. The cream was then added to the mixture and blended therein.

The butter was heated to a temperature of between about 140° F. and 145° F. The lecithin and Tween 60 were added to the melted butter and mixed therein.

The melted butter or oil fraction with the emulsifiers were added to the aqueous fraction and mixed into the aqueous fraction to create an oil-in-water emulsion. The emulsion was heated to about 150° F. and then homogenized at about 1500 psig through a single stage homogenizer.

The slurry was added to the homogenized emulsion to form the base. The base is heated to about 155° F. under agitation or shear for about 5 minutes to pasteurize the base. The base was then cooled in a refrigeration unit and stored under refrigeration until it is reconstituted to create a dairy based sauce such as a Béchamel sauce.

It was discovered that the use of MPC was an acceptable ingredient to add solids to the oil-in-water emulsion. The MPC provided a cooked, custard like flavor while the NFDM provided a more oatmeal like flavor. However, both NFDM and MPC are acceptable dairy powders for the oil-in-water emulsion. It was also observed that as the weight percent of starch was increased, the viscosity of the base also increased. It was also observed that the addition of sucrose increased the sweetness of the base.

### EXAMPLE 7

A series of trials were conducted to test the effectiveness of substituting dairy based powders including whey protein concentrate (WPC), sodium caseinate (NaCas) and milk protein concentrate (MPC) for NFDM. The formulations for the Trials are as follows.

TABLE 7

| | Trial 20 | Trial 21 | Trial 22 | Trial 23 | Trial 24 | Trial 25 |
|---|---|---|---|---|---|---|
| Ingredient | Wt. % | Wt. % | Wt. % | Wt. % | Wt. % | Wt. % |
| Water | 46.18 | 46.19 | 46.27 | 46.20 | 46.56 | 46.18 |
| Cream¹ | 30.00 | 30.00 | 30.00 | 30.00 | 30.00 | 30.00 |
| Liquid soy oil | 3.00 | 3.00 | 3.00 | 3.00 | 3.00 | 3.00 |
| Dairy solids | 8.00² | 1.89³ | 2.51⁵ | 4.08⁶ | 6.57⁷ | 8.00² |
| Salt | 1.00 | 1.00 | 1.00 | 1.00 | 1.00 | 1.00 |
| Starch | 5.75 | 5.75 | 5.75 | 5.75 | 5.75 | 5.75 |
| (Frigex W)⁸ | | | | | | |
| Butter - salted | 6.00 | 6.00 | 6.00 | 6.00 | 3.95 | 6.00 |
| Tween 60⁹ | 0.035 | 0.035 | 0.035 | 0.035 | 0.035 | 0.035 |
| Lecithin | 0.035 | 0.035 | 0.035 | 0.035 | 0.035 | 0.035 |
| Disodium | 0.00 | 0.00 | 0.00 | 0.00 | 0.00 | 0.10 |
| phosphate | | | | | | |
| Maltodextrin⁴ | 0.00 | 6.10 | 3.900 | 5.40 | 3.10 | 0.00 |
| Total wt. % | 100.00 | 100.00 | 100.00 | 100.00 | 100.00 | 100.00 |
| Wt. % moisture | 64.74 | 64.67 | 64.75 | 64.69 | 64.73 | 64.65 |
| Wt. % total | 35.26 | 35.33 | 35.25 | 35.31 | 35.27 | 35.35 |
| solids | | | | | | |
| Wt. % solids | 15.39 | 15.47 | 15.45 | 15.45 | 15.40 | 15.48 |
| non-fat | | | | | | |
| Wt. % fat | 19.87 | 19.86 | 19.80 | 19.86 | 19.87 | 19.87 |

¹The cream used in Trials 20-25 was Heavy Whipping Cream manufactured by Land O'Lakes, Inc. of Arden Hills, Minnesota.
²Non-fat dry milk manufactured by Land O'Lakes, Inc. of Arden Hills, MN.
³WPC-34 manufactured by Land O'Lakes, Inc. of Arden Hills Minnesota.
⁴The maltodextrin M100 is manufactured Grain Processing Corporation of Muscatine, Iowa.
⁵Sodium caseinate manufactured by Erie Foods International, Inc. of Erie Illinois.
⁶Milk protein concentrate, MPC 4700, is Alapro 4700 manufactured by Fonterra Co-operative Group Ltd of New Zealand.
⁷Milk protein concentrate, MPC 4424, manufactured by by Fonterra Co-operative Group Ltd of New Zealand.
⁸Modified Starch - National Starch and Chemical Company, New Jersey.
⁹Polyethylene sorbitan monostearate.

Each of the trials was produced using the procedure disclosed in Example 6. The disodium phosphate was added to the water prior to the addition of NFDM in Trial 25. Maltodextrin was added to Trials 21-24 to maintain the total solids to that of the total solids in Trial 20.

The amount of dairy solids added to each trial was calculated to provide the same amount of protein to the overall oil-in-water emulsion. Based upon the weight percent protein of the ingredients, the weight percent of the dairy powder was adjusted. It was determined that NFDM contributed 2.72 weight percent protein to the overall emulsion (8 wt %×34 wt % protein)/100. Each of the dairy powders was added to match the 2.72 weight percent protein contribution by the NFDM. WPC-34 was determined to have 29.28 weight percent protein. Sodium caseinate was determined to have 89 weight percent protein. MPC 4700 had 68.58 weight percent protein and MPC 4424 had 42.50 weight percent protein.

It was determined that each of the tested substitutes for NFDM was acceptable. Trial 21 using the WPC was thinner looking than the control of Trial 20. The viscosity of Trial 21 was about one half the viscosity of the control when reconstituted.

Trial 22 using the sodium caseinate produced a thin product that started to thicken at about 155° F. when reconstituted and heated. The emulsion had a smooth appearance when reconstituted.

The emulsion of Trial 23 produced a base that was similar to the control of Trial 20 in consistency and viscosity. The emulsion of Trial 23 made a more aerated sauce and had a stronger dairy flavor than the control.

The emulsion of Trial 24 produced a base that was similar to the control of Trial 20 in consistency and viscosity. The emulsion of Trial 24 had an astringent flavor as compared to the control, but the flavor was acceptable.

The addition of disodium phosphate in Trial 25 produced an emulsion that was slightly thinner than the control when exiting the homogenizer. When reconstituted and heated, the disodium phosphate produced a thicker, more viscous sauce.

### EXAMPLE 8

A series of trials were conducted to evaluate the effect of combining two or more diary powders in the oil-in-water emulsion. The formulations are as follows.

TABLE 8

| | Trial 26 | Trial 27 | Trial 28 | Trial 29 | Trial 30 | Trial 31 | Trial 32 | Trial 33 |
|---|---|---|---|---|---|---|---|---|
| Ingredient | Wt. % | Wt. % | Wt. % | Wt. % | Wt. % | Wt. % | Wt. % | Wt. % |
| Water | 44.825 | 47.49 | 44.82 | 42.155 | 47.49 | 44.82 | 42.15 | 44.83 |
| Cream¹ | 30.00 | 30.00 | 30.00 | 30.00 | 30.00 | 30.00 | 30.00 | 30.00 |
| Liquid soy oil | 3.00 | 3.00 | 3.00 | 3.00 | 3.00 | 3.00 | 3.00 | 3.00 |
| NFDM² | 8.00 | 2.67 | 5.34 | 8.00 | 0.00 | 2.67 | 5.34 | 0.00 |
| WPC 34%³ | 0.00 | 2.67 | 2.67 | 2.67 | 5.34 | 5.34 | 5.34 | 8.00 |
| Salt | 1.00 | 1.00 | 1.00 | 1.00 | 1.00 | 1.00 | 1.00 | 1.00 |
| Dry sucrose | 1.00 | 1.00 | 1.00 | 1.00 | 1.00 | 1.00 | 1.00 | 1.00 |
| Starch (Frigex W)⁴ | 5.75 | 5.75 | 5.75 | 5.75 | 5.75 | 5.75 | 5.75 | 5.75 |
| Potassium Sorbate | 0.125 | 0.125 | 0.125 | 0.125 | 0.125 | 0.125 | 0.125 | 0.125 |
| Tween 60⁵ | 0.035 | 0.035 | 0.035 | 0.035 | 0.035 | 0.035 | 0.035 | 0.035 |
| Lecithin | 0.035 | 0.035 | 0.035 | 0.035 | 0.035 | 0.035 | 0.035 | 0.035 |
| Lactic acid 88% | 0.23 | 0.23 | 0.23 | 0.23 | 0.23 | 0.23 | 0.23 | 0.23 |
| Total wt. % | 100.00 | 100.00 | 100.00 | 100.00 | 100.00 | 100.00 | 100.00 | 100.00 |
| Wt. % moisture | 64.21 | 66.80 | 64.22 | 61.65 | 66.81 | 64.23 | 61.66 | 64.26 |
| Wt. % total solids | 35.79 | 33.20 | 35.78 | 38.35 | 33.19 | 35.77 | 38.34 | 35.74 |
| Wt. % solids non-fat | 17.12 | 14.50 | 17.06 | 19.61 | 14.43 | 16.98 | 19.54 | 16.90 |
| Wt. % fat | 18.67 | 18.70 | 18.72 | 18.74 | 18.76 | 18.78 | 18.80 | 18.84 |

¹The cream used in Trials 26-33 was Heavy Whipping Cream manufactured by Land O'Lakes, Inc. of Arden Hills, Minnesota.
²NFDM (non-fat dry milk) manufactured by Land O'Lakes, Inc. of Arden Hills, MN.
³WPC-34 manufactured by Land O'Lakes, Inc. of Arden Hills Minnesota.
⁴Modified Starch - National Starch and Chemical Company, New Jersey.
⁵Polyethylene sorbitan monostearate.

Each of the trials was produced using the method disclosed in Example 1. The heat stable oil-in-water emulsion or base was found to be repeatedly cyclable from refrigerated temperature to cooking temperatures and back to the refrigerated temperature without churning out or creaming. In addition, the heat stable oil-in-water emulsion demonstrated excellent freeze-thaw stability. The base was a concentrate that was reconstituted with about two times the weight of the base and when reconstituted had the organoleptic properties of a made from scratch Béchamel sauce.

It was discovered that both NFDM and WPC individually or in combination were acceptable ingredients for the oil-in-water emulsion of the present invention. It was also discovered that NFDM provided a buffering effect on pH when compared to WPC. Also emulsions produced using NFDM had higher viscosities than emulsions produced with WPC.

### EXAMPLE 9

A series of trials were conducted to determine during which step in the process that the acid should be added to produce the heat stable oil-in-water emulsion. The formulation for each trial was substantially the same and is reproduced below as follows.

TABLE 9

| Ingredient | Wt. % |
|---|---|
| Water | 44.825 |
| Cream¹ | 30.00 |
| Liquid soy oil | 3.00 |
| NFDM² | 8.00 |
| Salt | 1.00 |
| Dry sucrose | 1.00 |
| Starch (Frigex W)³ | 5.75 |
| Butter - salted | 6.00 |
| Potassium Sorbate | 0.125 |
| Tween 60⁴ | 0.035 |
| Lecithin | 0.035 |
| Lactic acid 88% | 0.23 |
| Total wt. % | 100.00 |
| Wt. % moisture | 64.21 |
| Wt. % total solids | 35.79 |
| Wt. % solids non-fat | 17.12 |
| Wt. % fat | 18.67 |

¹The cream used in the trial was Heavy Whipping Cream manufactured by Land O'Lakes, Inc. of Arden Hills, MN.
²NFDM (non-fat dry milk) manufactured by Land O'Lakes, Inc. of Arden Hills, MN.
³Modified Starch - National Starch and Chemical Company, New Jersey.
⁴Polyethylene sorbitan monostearate.

The emulsion was prepared using the procedure disclosed in Example 1. However, the addition of the lactic acid was varied. In one trial all of the lactic acid was mixed into the slurry containing the starch and a portion of the water. In a second trial, all of the lactic acid was mixed into the slurry and the potassium sorbate was added to the aqueous component. In a third trial, half of the lactic acid was mixed into the slurry and half was mixed into the aqueous component. In a final trial all of the lactic acid was mixed into the aqueous component.

The trials showed that the sauce with the most appealing appearance, taste and texture was produced when the lactic acid was added to both the slurry and the aqueous component. Adding the lactic acid to both the slurry and the aqueous component produced an oil-in-water emulsion having a milky taste and a mouthfeel that was most similar a made from scratch sauce. However, the other trials produced acceptable sauces that had a buttery taste.

Although the present invention has been described with reference to preferred embodiments, workers skilled in the art will recognize that changes may be made in form and detail without departing from the spirit and scope of the invention.

What is claimed is:

1. A method of forming a heat stable oil-in-water emulsion comprising:
providing a selected amount of an aqueous component;
heating the aqueous component to a temperature sufficient to avoid whipping and churning of the aqueous component with the application of a shear force;
adding a selected amount of a solids component to the aqueous component under agitation to form a first intermediate;
heating a selected amount of a fat containing component to a temperature sufficient to melt a sufficient amount of the fat containing component so that the fat containing component becomes fluid;
adding an emulsifier either to the aqueous component or to the fat containing component or both;
adding the heated fat containing component to the first intermediate with sufficient agitation to disperse the added fat containing component in the first intermediate to form a second intermediate;
homogenizing the second intermediate at between about 250 psig and 5000 psig to form the heat stable oil-in-water emulsion comprising at least 5 weight percent fat; and
adding a selected amount of a thickening agent to the homogenized heat stable oil-in-water emulsion for making a base for a Béchamel sauce.

2. The method of claim 1 wherein the second intermediate is heated for a selected period of time

3. The method of claim 2 wherein the second intermediate is homogenized at a temperature sufficient to maintain the fat containing component in a fluid condition.

4. The method of claim 1 wherein the aqueous component comprises cream or milk.

5. The method of claim 1 wherein the aqueous component comprises between about 36 weight percent fat and about 44 weight percent fat.

6. The method of claim 1 wherein the solids component comprises nonfat milk solids, milk protein concentrate, whey protein concentrate, multodextrin or any combination thereof.

7. The method of claim 6 wherein the selected amount of the solids component is between about 3 and 10 weight percent of the heat stable oil-in-water emulsion.

8. The method of claim 1 wherein the fat containing component comprises milk fat, vegetable oil, butter or any combination thereof.

9. The method of claim 8 wherein a combination of milk fat and vegetable oil is in an amount sufficient to provide a heat-stable oil-in-water emulsion comprising less than about 20% fat.

10. The method of claim 8 wherein the selected amount of butter is an amount sufficient to provide a heat-stable oil-in-water emulsion comprising less than 20% fat.

11. The method of claim 8 wherein the selected amount of butter is between about 2 weight percent and about 8 weight percent.

12. The method of claim 9 wherein the selected amount of vegetable oil is between about 0.1 weight percent and about 5 weight percent.

13. The method of claim 1 further comprising adding stabilizers to the heated aqueous component.

14. The method of claim 1 further comprising adding enhancing ingredients to the aqueous component, the fat contain a component, the first intermediate, the second intermediate or the finished heat, stable oil-in-water emulsion.

15. The method of claim 1 wherein the thickening agent comprises a starch or a gum or a combination thereof.

16. The method of claim 1 wherein the thickening agent mixes with a selected amount of water to create a slurry wherein the slurry is added to the homogenized heat stable oil-in-water emulsion.

17. The method of claim 16 wherein the slurry comprises between about 30 weight percent and about 35 weight percent total solids.

18. The method of claim 1 wherein the selected amount of thickening agent is between about 2 weight percent and 10 weight percent of the oil-in-water emulsion.

19. The method of claim 1 wherein the oil-in-water emulsion comprises between about 50 weight percent and about 70 weight percent water.

20. The method of claim 1 wherein the oil-in-water emulsion comprises between about 3 weight percent and about 20 percent oil.

21. The method of claim 1 wherein the oil-in-water emulsion comprises between about 25 weight percent and about 45 weight percent total solids.

22. The method of claim 1 wherein the oil-in-water emulsion comprises between about 10 weight percent and about 20 weight percent solids non-fat.

23. A sauce base comprising:
an aqueous component wherein the aqueous component comprises more than 50 weight percent moisture;
a solids component wherein the solids component comprises protein wherein the solids component has been added to the aqueous component to form a first intermediate;
a fat containing component wherein the fat containing component has been added to the first intermediate to form a second intermediate and wherein the fat concentration of the base is less than 25 weight percent;
an emulsifier wherein the emulsifier has been added to the aqueous component or to the fat containing component or both and wherein the aqueous component, the solids component the fat containing component and the emulsifier have been added together such that the protein concentration of the base is in a range of greater than 2 weight percent and less than 10 weight percent and wherein the base has been homogenized; and
an amount of a thickening agent effective to increase a viscosity of the homogenized oil-in-water emulsion such that the emulsion comprises an oil-in-water emulsion that is storable, heat stable and usable for a dairy based sauce having the organoleptic properties of a made from scratch dairy based sauce.

24. The base of claim 23 wherein the fat concentration of the base comprises between about 3 weight percent and 20 weight percent of the base.

25. The base of claim 23 wherein a moisture concentration of the base comprises between about 45 weight percent and 70 weight percent of the base.

26. The base of claim 23 wherein a solids non-fat content of the base is greater than 3 weight percent and less than or equal to 25 weight percent of the base.

27. The base of claim 23 wherein the aqueous component comprises a cream or milk.

28. The base of claim 23 wherein the solids component comprises non-fat dry milk, whey protein concentrate, milk protein concentrate or multodextrin or any combination thereof.

29. The base of claim 23 wherein the solids component comprises between about 1.5 weight percent and 12 weight percent.

30. The base of claim 23 wherein the fat containing component comprises milk fat, vegetable oil, butter or any combination thereof.

31. The base of claim 30 wherein the vegetable oil comprises between about 1 weight percent and about 5 weight percent of the total weight of the base.

32. The base of claim 30 wherein the butter comprises between about 1 weight percent and about 10 weight percent of the total weight of the base.

33. The base of claim 23 and further comprising stabilizers.

34. The base of claim 23 and further comprising enhancing ingredients.

35. The base of claim 23 wherein the thickening agent comprises a starch or a gum or any combination thereof.

36. The base of claim 35 wherein the starch comprises between about 1 weight percent and about 10 weight percent of the total weight of the base.

37. The base of claim 35 and wherein the thickening agent is added to a liquid to form a slurry wherein the slurry comprises between about 30 weight percent and about 35 weight percent of total solids.
